(19) United States
(12) Patent Application Publication
(10) Pub. No.: US 2025/0313135 A1
(43) Pub. Date: Oct. 9, 2025

(54) CHILD SAFETY SEAT AND SUPPORT DEVICE THEREOF

(71) Applicant: WONDERLAND SWITZERLAND AG, Steinhausen (CH)

(72) Inventor: Manqun CHENG, Dongguan (CN)

(21) Appl. No.: 18/865,426

(22) PCT Filed: May 15, 2023
(86) PCT No.: PCT/EP2023/062968

§ 371 Date: Nov. 13, 2024

(30) Foreign Application Priority Data
May 13, 2022 (CN) 202210523214.1
Oct. 28, 2022 (CN) 202211335936.0

(51) Int. Cl. B60N 2/26; B60N 2/28; B60R 21/02

(52) U.S. Cl. CPC B60N 2/268; B60N 2/2824; B60R 2021/022

(57) ABSTRACT

A child safety seat and a support device thereof. The support device includes a support leg body, a bottom leg, a trigger, and an alarm unit. The bottom leg is connected to a bottom end of the support leg body, and the bottom leg and the support leg body form a receiving space. The trigger is movably connected to the bottom leg and is movable between a first position and a second position. In the first position, at least a portion of the trigger protrudes from the bottom leg, and in the second position, the trigger is received in the receiving space. The alarm unit includes a switch module and a wireless module. The switch module is configured to acquire a floor contact signal indicating that the trigger is in the second position, and the wireless module is in signal communication with the switch module.

### CROSS-REFERENCE OF RELATED APPLICATION

This application is a U.S. National Stage of International Application No PCT/EP2023/062968, filed on May 15, 2023, which claims the priorities of Chinese patent application 202210523214.1, filed on May 13, 2022, and entitled “EXTENDABLE AND RETRACTABLE LEG AND CHILD SAFETY SEAT”, and Chinese patent application 202211335936.0, filed on Oct. 28, 2022, and entitled “CHILD SAFETY SEAT AND SUPPORT DEVICE THEREOF”, the entire contents of which are incorporated herein by reference in their entireties.

### TECHNICAL FIELD

The present disclosure relates to the technical field of infant products, and more particularly, to a child safety seat mounted in a vehicle and a support device thereof.

### BACKGROUND

The child safety seat is a device specially designed for children of different weights or ages. The child is restrained in the safety seat during a ride, so that in the case of a car collision or a sudden deceleration of the vehicle, the impact on the child may be reduced and the body movement of the child may be limited, thereby reducing damage to the child, and effectively improving the safety of the children in the vehicle.

In order to prevent the child safety seat from moving forward or avoid rollover of the child safety seat in the case of violent bumping caused by a collision or an emergency brake of the vehicle, the safety seat of the related art is generally provided with a support device. In the child safety seat, generally, the support device is pivotally mounted at the front end of the base of the child safety seat. The support device has a folded position, where the support device is hidden in or under the base, and has an unfolded position, where the support device abuts against the interior floor of the vehicle. When the child safety seat is fixed on the seat in the vehicle, the support device is switched from the folded position to the unfolded position. Then the length of the support device is adjusted according to the an actual situation so that the support device abuts against the interior floor of the vehicle firmly, and the support device forms a reliable support for the front end of the base of the child safety seat, thereby effectively preventing a forward tilting movement of the child safety seat during an emergency brake of the vehicle and improving the safety of the child.

After the child safety seat is mounted on the seat of the vehicle, the support device is in contact with the floor of the vehicle so that the stability of the installation of the child safety seat is improved.

During the use of the support device, there may be a case that the support device is not in contact with the floor of the vehicle. In the related art, a support indicating device is provided on the child safety seat to indicate whether the support device is installed in place. However, the acceleration, deceleration, or turning of the vehicle during the ride may cause the position of the support device to change.

In addition, the support device generally includes a first leg tube and a second leg tube. The first leg tube is arranged with two or more positioning holes. The second leg tube is slidably sleeved in the first leg tube and arranged with a second engaging member. The second engaging member may engage with any positioning hole to lock the extension or retraction position of the second leg tube relative to the first leg tube, and may disengage from the positioning hole to allow the extension or retraction position of the second leg tube relative to the first leg tube to be adjusted. In order to ensure the strength of the locking and the strength of the supporting of the support device abutting against the floor, the second engaging member, the first leg tube and the second leg tube are generally made of a metallic material.

### SUMMARY

In one aspect, an embodiment of the present disclosure provides a support device applied to a child safety seat. The support device includes a support leg body, a bottom leg, a trigger, and an alarm unit. The bottom leg is connected to a bottom end of the support leg body, and forms a receiving space between the bottom leg and the support leg body. The trigger is movably connected to the bottom leg. The trigger is movable between a first position where at least a portion of the trigger protrudes from the bottom leg, and a second position where the trigger is received in the receiving space. The alarm unit includes a switch module configured to acquire a floor contact signal indicating that the trigger is in the second position, and a wireless module, which is in signal connection with the switch module.

In another aspect, an embodiment of the present disclosure provide a support device including: a first leg tube provided with a plurality of first positioning holes in a height direction; a second leg tube slidably sleeved in the first leg tube; a locking device mounted on the second leg tube and having a second engaging member, wherein the second engaging member moves between a locked position where the second engaging member engages with a corresponding positioning hole, and an unlocked position where the second engaging member is withdrawn from the corresponding positioning hole; and a cushioning member provided on at least one of an inner side wall of the first leg tube and the second engaging member, for cushioning a collision between the second engaging member and the first leg tube during sliding of the second leg tube.

In still another aspect, an embodiment of the present disclosure provides a child safety seat. A front end of a base of the child safety seat is provided with a support device described above, and the first leg tube of the support device is connected to the front end of the base.

### BRIEF DESCRIPTION OF THE DRAWINGS

FIG. 1 shows a perspective view of a child safety seat according to some embodiment of the present disclosure, where, a support device is in an unfolded state and a seat body is not shown.

FIG. 2 shows another perspective view of the child safety seat according to some embodiment of the present disclosure, where the support device is in a folded state and the seat body is not shown.

FIG. 3 shows still another perspective view of the child safety seat according to some embodiment of the present disclosure, where the support device is in the unfolded state, and the seat body and an upper housing of a base are not shown.

FIG. 4 shows a sectional view of the support device according to some embodiment of the present disclosure.

FIG. 5 shows a partially enlarged view of a portion X in FIG. 4.

FIG. 6 shows a schematic view of the support device of FIG. 4, where a support leg body and a support member are not shown.

FIG. 7 shows a perspective view of the support device according to some embodiment of the present disclosure.

FIG. 8 shows an exploded schematic view of a locking structure according to some embodiment of the present disclosure.

FIG. 9 shows another perspective view of the support device according to some embodiment of the present disclosure.

FIG. 10 shows a longitudinal sectional view of the support device according to some embodiment of the present disclosure, where a second engaging member engages with a positioning hole.

FIG. 11 shows another longitudinal sectional view of the support device according to some embodiment of the present disclosure, where the second engaging member and a second shaft are shown in an exploded manner for ease of understanding.

FIG. 12 shows a sectional view of a second leg tube of the support device according to some embodiment of the present disclosure.

FIG. 13 shows a perspective view of a bar-shaped adjustment member of the support device according to some embodiment of the present disclosure.

FIG. 14 shows a perspective view of a first leg tube of the support device according to some embodiment of the present disclosure.

The reference numerals are described as follows:
200, base; 200a, upper housing; 200b, lower housing; 100, support device; 10, support leg body; 101, first end portion; 102, second end portion; 110, fixing member; 111, opening; 1, first leg tube; 2, second leg tube; 131, locking hole; 20, bottom leg; 201, contacting-floor surface; 202, through hole; 210, foundation member; 220, cushioning member; 30, trigger; 310, base body; 3101, guiding hole; 320, triggering part; 330, contacting-floor part; 40, alarm unit; 410, switch module; 411, circuit board; 412, switch; 413, switch body; 414, contact terminal; 420, wireless module; 430, wire; 50, first elastic restoring member; 60, guiding post; 70, support member; 80, locking structure; 810, bracket; 820, first engaging member; 821, guiding ramp; 822, engaging hook; 830, fixing cover; 831, window; 840, first button; 850, restoring member; 860, rotating shaft; S, receiving space; 101′, abutted wall; 102′, bottom wall; 103, inner side wall; 104, side wall; 10′, first positioning hole; 11, adjustment member; 13, third cushioning layer; 15, stopper; 200c, pivot seat; 2, second leg tube; 21, bottom leg; 22, positioning member; 25, first circular hole; 3, locking device; 31, second engaging member; 311, first end; 312, second end; 313, second positioning hole; 3121, horizontal plane region; 3122, inclined plane region; 32, operating button; 321, first inclined surface; 33, traction member; 35, second elastic restoring member; 38, second circular hole; 331, first long hole; 332, second long hole; 333, third long hole; 337, second inclined surface; 51, first shaft; 52, second shaft; and 53, third shaft.

### DETAILED DESCRIPTION OF THE EMBODIMENTS

Exemplary embodiments are described more comprehensively with reference to the accompanying drawings. However, the exemplary embodiments may be implemented in various forms and should not be understood to be limited to the embodiments set forth herein. On the contrary, these embodiments are provided so that the present disclosure will be comprehensive and complete, and the concept of the exemplary embodiments will be comprehensively understood by those skilled in the art. The same reference numerals in the drawings indicate the same or similar structures, thus they will not be described hereinafter in detail.

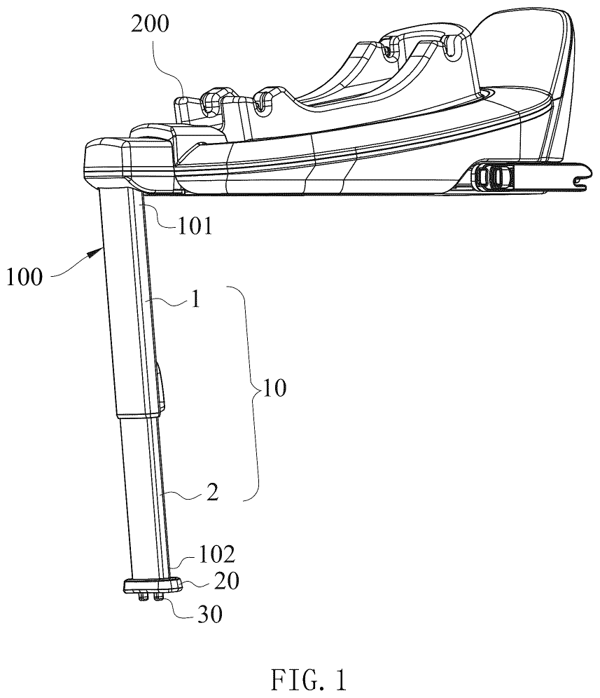

As shown in FIGS. 1 to 3, a child safety seat according to some embodiment of the present disclosure includes a base 200 and a support device 100 according to any embodiment of the present disclosure. The base 200 may be mounted on a vehicle. For example, the base 200 may be mounted on the vehicle by an ISOFIX socket mounting manner, a seat belt mounting manner, or the like. An end of the support device 100 is connected to the base 200. For example, the support device 100 is connected to a front end of the base 200. The child safety seat further includes a seat body (not shown). The seat body is disposed on the base 200 and arranged for allowing a child to be seated on. After the base 200 is mounted on the vehicle, the other end of the support device 100 abuts against the floor of the vehicle, so that the child safety seat is stably mounted on the vehicle.

It should be understood that the terms “comprise”, “include” and “have” and any variations thereof in the embodiments of the present disclosure are intended to cover non-exclusive inclusion. For example, a process, a method, a system, a product, or an apparatus that includes a series of steps or units is not limited to the listed steps or units, but optionally further includes steps or units not listed, or optionally further includes other steps or components inherent to such a process, a method, a product, or an apparatus.

The base 200 includes an upper housing 200a and a lower housing 200b, and the upper housing 200a is connected to the lower housing 200b. The seat body is attached to the upper housing 200a.

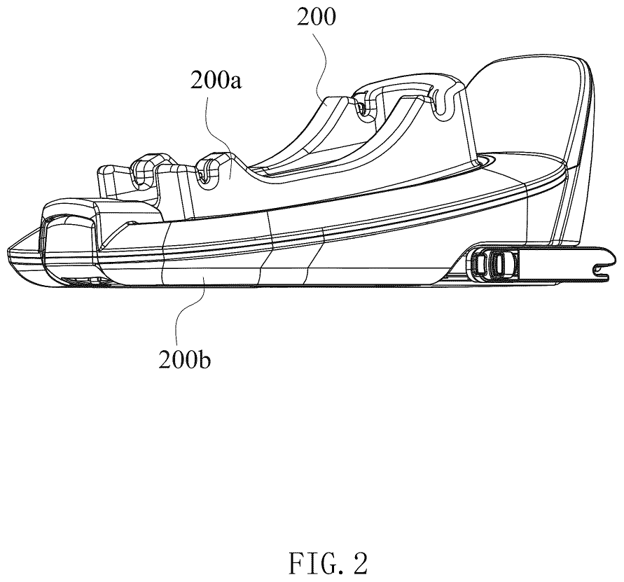

In some embodiment, an end of the support device 100 is rotatably connected to the base 200. As shown in FIGS. 1 and 2, when the support device 100 is in an unfolded state with respect to the base 200, the support device 100 is arranged at an angle to the base 200. For example, the support device 100 and the base 200 is perpendicular to each other, but the present disclosure is not limited thereto. When the support device 100 is in a folded state with respect to the base 200, the support device 100 is received in the bottom side of the base 200 to facilitate transportation and storage of the child safety seat.

In some embodiment, the support device 100 is fixedly connected to the base 200.

In some embodiment, the support device 100 is slidably connected to the base 200. When the support device 100 is in the unfolded state with respect to the base 200, the support device 100 slides out from the base 200. When the support device 100 is in the folded state with respect to the base 200, the support device 100 slides into and is received in the base 200.

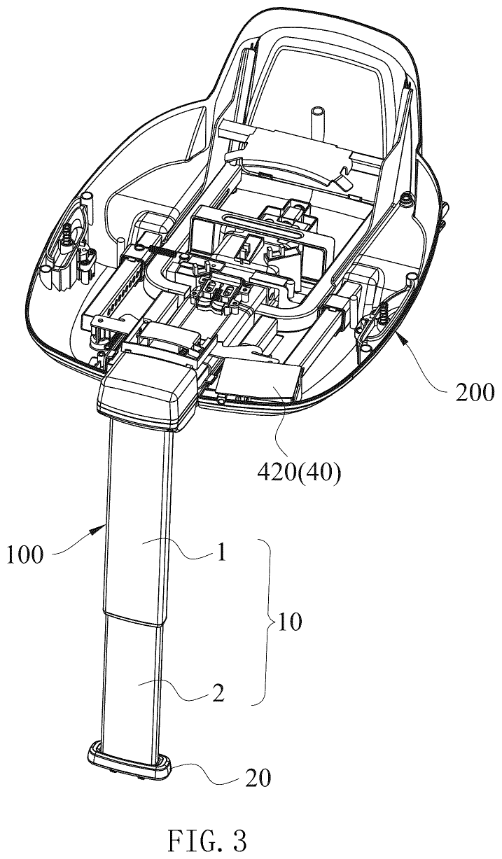

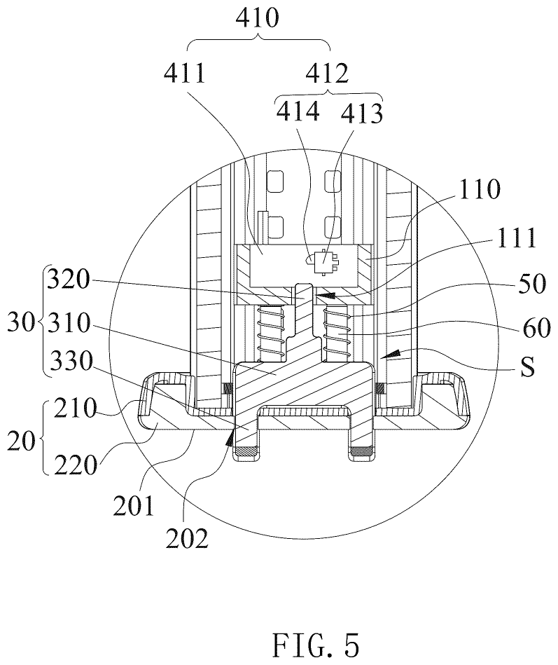

As shown in FIGS. 3 to 6, the support device 100 includes a support leg body 10, a bottom leg 20, a trigger 30, and an alarm unit 40. As shown in FIGS. 1 and 5, the support leg body 10 includes a first end portion 101 and a second end portion 102. The first end portion 101 is a top end of the support leg body 10, and is connected to a component of the child safety seat, for example, to the base 200 of the child safety seat. As a specific example, the first end portion 101 of the support leg body 10 is fixedly or rotatably connected to the base 200. The second end portion 102 is a bottom end of the support leg body 10, and the bottom leg 20 is connected to the second end portion 102. When the support device 100 supports on the floor of the vehicle, the bottom leg 20 is in contact with the vehicle floor. The trigger 30 is movably connected to the bottom leg 20 and is movable between a first position and a second position. In the first position, at least a portion of the trigger 30 protrudes from the bottom leg 20, and in the second position, the trigger 30 is received in a receiving space S. The alarm unit 40 includes a switch module 410 and a wireless module 420. The switch module 410 is configured to acquire a floor contact signal indicating that the trigger 30 is in the second position. The wireless module 420 is in a signal communication with the switch module 410 and is configured to transmit the floor contact signal to a terminal. It should be understood that, when the bottom leg 20 is separated from the ground, at least a portion of the trigger 30 protrudes from the bottom leg 20 in the first position. When the support device 100 of the embodiment of the present disclosure is subjected to a pressing force in the height direction, the trigger 30 moves from the first position to the second position with respect to the bottom leg 20 under the pressing force. When the trigger 30 moves to the second position, the trigger 30 is received in the receiving space S, such that the bottom leg 20 is in contact with the floor of the vehicle, and the state of the bottom leg 20 is in contact with the floor. The switch module 410 acquires the floor contact signal when the trigger 30 is in the second position, and the wireless module 420 sends the floor contact signal to a terminal, thereby realizing real-time monitoring of the floor contact state of the bottom leg 20, and avoiding the danger caused by the loosening of the support device 100.

In the embodiments of the present disclosure, a height direction refers to a height direction of the support device in use.

Further, since at least a portion of the trigger 30 protrudes from the bottom leg 20 in the first position, when the support device 100 is in contact with the floor of the vehicle, the pressing force applied to the support device 100 directly exerts on the portion of the trigger 30 that protrudes from the bottom leg 20, forcing the trigger 30 to move from the first position to the second position until the switch module 410 is triggered to generate a floor contact signal. The trigger 30 moves with respect to the bottom leg 20 more directly and flexibly, thereby avoiding the occurrence of such a situation that the trigger 30 gets stuck to stop the switch module 410 from acquiring the floor contact signal, thus disenabling the terminal to accurately monitor the floor contact state of the support device 100.

The switch module 410 is disposed within the support leg body 10. As a specific example, the switch module 410 is disposed at the second end portion 102 of the support leg body 10.

In some embodiment, the switch module 410 is provided at the first end portion 101 of the support leg body 10, or the switch module 410 is provided at a position between the first end portion 101 and the second end portion 102 of the support leg body 10.

It should be understood that the term “signal communication” is a wired connection or a wireless communication. For a wireless communication, it is done by Wi-Fi, Bluetooth, and other means.

For example, the terminal include a mobile terminal, a child safety seat display, an in-vehicle display, and the like.

The mobile terminal is a mobile phone, a notebook computer, a pad, or the like. When the terminal includes a mobile phone, the mobile phone is in signal communication with the wireless module 420, and the user may monitor the floor contact state of the support device 100 in real time through the mobile phone. During a drive of the vehicle, it may be found that the support device 100 is off the floor of the vehicle and such a case is processed in time, so as to avoid danger. When the terminal includes the child safety seat display, the display is provided on a position which makes it easy for the user to observe the display, such as on the support leg body 10, on the base 200, or on the seat body, etc. When the terminal includes the in-vehicle display, the in-vehicle display is disposed in a central control area of the vehicle, so that the user may monitor the floor contact state of the support device 100 in real time when driving the vehicle.

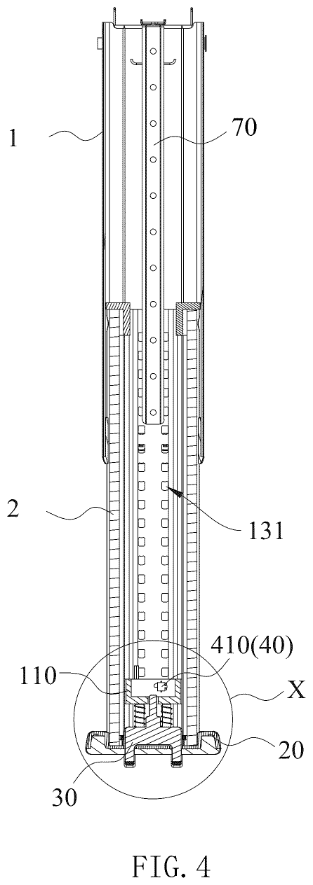

As shown in FIG. 4, the trigger 30 is movably connected to the bottom leg 20. The trigger 30 is movable in an extension direction of the support leg body 10. That is, the movement direction of the trigger 30 with respect to the bottom leg 20 is parallel to the height direction of the support leg body 10. When the trigger 30 is in the first position and subjected to a pressing force, the trigger 30 moves along the height direction of the support leg body 10 toward the second position.

In some embodiment, the movement direction of the trigger 30 with respect to the bottom leg 20 is unparallel to the height direction of the support leg body 10, for example, there may be an angle between these two directions.

The support leg body 10 includes a first leg tube 1 and a second leg tube 2. The first leg tube 1 and the second leg tube 2 are connected in an extendable and retractable manner. The first end portion 101 is provided at an end of the first leg tube 1, and the second end portion 102 is provided at an end of the second leg tube 2 away from the first leg tube 1. By an extendable and retractable connection of the first leg tube 1 and the second leg tube 2, the length of the support leg body 10 is adjusted as needed, so as to accommodate different vehicle types.

In some embodiment, the first leg tube 1 is sleeved over the second leg tube 2. In other embodiments, the second leg tube 2 is sleeved over the first leg tube 1.

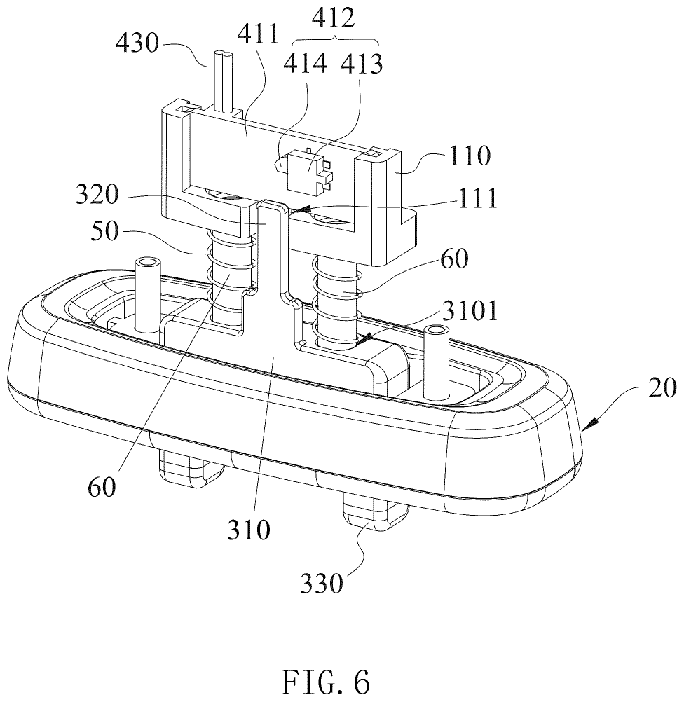

As shown in FIGS. 5 and 6, in some embodiment, a fixing member 110 is fixedly disposed inside the support leg body 10, and the switch module 410 is connected to the fixing member 110. The fixing member 110 is arranged to be opposite to the trigger 30 in the height direction of the support leg body 10. The fixing member 110 is fixedly connected to the bottom leg 20, and the fixing member 110 may also be fixedly connected to an inner wall surface of the second leg tube 2. For example, the fixing member 110 and the second leg tube 2 may be integrally constructed or may be connected by welding. The fixing member 110 is disposed at the second end portion 102 of the second leg tube 2.

In some embodiment, the support device 100 further includes a first elastic restoring member 50. One end of first elastic restoring member 50 is arranged to abut against the trigger 30, and the other end is arranged to abut against the fixing member 110. The first elastic restoring member 50 is configured to apply an elastic force to the trigger 30 to drive the trigger 30 to move towards the first position. When the trigger 30 is not subjected to the pressing force, the trigger 30 is in the first position under the action of the first elastic restoring member 50, that is, at least a portion of the trigger 30 protrudes from the bottom leg 20. When the trigger 30 is subjected to the pressing force, the trigger 30 moves from the first position to the second position and gradually presses the first elastic restoring member 50, so that the first elastic restoring member 50 is compressed. When the trigger 30 moves to the second position, the switch module 410 is triggered, and the trigger 30 is received in the receiving space S, so that the bottom leg 20 is in contact with the vehicle floor. When the support device 100 is folded, no pressing force is exerted on the trigger 30, and under the action of the first elastic restoring member 50, the trigger 30 moves from the second position to the first position, and the state, in which at least a portion of the trigger 30 protrudes from the bottom leg 20, is restored.

In some embodiment, the first elastic restoring member 50 is a spring, an elastic rubber member, or any other member capable of restoring the trigger 30.

The switch module 410 includes a circuit board 411 and a switch 412 that is mechanically and electrically connected to the circuit board 411. The circuit board 411 is embedded in the fixing member 110 and is communication with the wireless module 420. The switch 412 includes a switch body 413, and a contact terminal 414 connected to the switch body 413. After the pressing force is applied to the trigger 30, the trigger 30 moves toward the second position to be in contact with the contact terminal 414, thereby generating a floor contact signal. The floor contact signal is transmitted to the terminal through the wireless module 420 to enable the user to monitor the floor contact state of the support device 100 in real time.

The fixing member 110 has an opening 111, and the trigger 30 is movable and arranged to pass through the opening 111. When the trigger 30 is in the first position, the trigger 30 is provided to pass through the opening 111 of the fixing member 110, while the trigger 30 is not in contact with the switch 412. When the trigger 30 moves from the first position to the second position, the trigger 30 moves and passes through the opening 111 of the fixing member 110.

As shown in FIG. 5, the trigger 30 may include a base body 310, a triggering part 320, and a contacting-floor part 330. The base body 310 is disposed on a side of the bottom leg 20 facing the support leg body 10. The triggering part 320 is attached to a side of the base body 310 facing the fixing member 110. The contacting-floor part 330 is attached to another side of the base body 310 away from the fixing member 110, and the contacting-floor part 330 is movably arranged to pass through through holes 202 in the bottom leg 20. The through holes 202 are configured to go through the bottom leg 20 and communicate with the receiving space S.

When the trigger 30 is in the first position, under the elastic force of the first elastic restoring member 50, the base body 310 abuts against the bottom leg 20, and a portion of the contacting-floor part 330 protrudes from the bottom leg 20. During a movement of the trigger 30 from the first position to the second position, the base body 310 presses the first elastic restoring member 50, and the triggering part 320 moves in the opening 111 of the fixing member 110 and gradually approaches the switch 412. At the same time, the contacting-floor part 330 retracts into the receiving space S along the through hole 202. When the trigger 30 moves to the second position, the triggering part 320 triggers the switch 412 to generate a floor contact signal, and the contacting-floor part 330 retracts into the receiving space S.

In some embodiment, the contact terminal 414 abuts against a side surface of the triggering part 320 when the trigger 30 is in the second position.

In some embodiment, as shown in FIGS. 5 and 6, a guiding hole 3101 is disposed on the base body 310 of the trigger 30. A guiding post 60 is disposed between the fixing member 110 and the bottom leg 20. By the arrangement of the guiding post 60 and the guiding hole 3101, the extension and retraction of the trigger 30 with respect to the bottom leg 20 are guided, so that the movement direction of the trigger 30 with respect to the bottom leg 20 is not inclined, thereby ensuring that the trigger 30 can accurately trigger the switch module 410.

In some embodiment, the guiding post 60 extends along the height direction of the support leg body 10 and is slidably arranged to pass through the guiding hole 3101 in the base body 310.

In some embodiment, both the number of the guiding posts 60 and the number of the guiding holes 3101 are two, and the two guiding posts 60 are arranged to pass through the two guiding holes 3101, respectively. The triggering part 320 of the trigger 30 is located between the two guiding posts 60.

In some embodiment, the guiding hole 3101 is arranged in the base body 310 of the trigger 30, and one end of the guiding post 60 is connected to the side of the bottom leg 20 facing the support leg body 10, and the other end of the guiding post 60 is fixedly connected to a side of the fixing member 110 adjacent to the bottom leg 20. That is, the guiding post 60 is fixedly arranged between the fixing member 110 and the bottom leg 20, thereby enhancing the connection strength of the guiding post 60, and ensuring that the trigger 30 can stably slide between the first position and the second position along the guiding post 60.

In some embodiment, the number of the first elastic restoring members 50 are two, and the two first elastic restoring members 50 are sleeved over the two guiding posts 60, respectively.

In some embodiment, the trigger 30 is provided with a projection, an inner wall of the second leg tube 2 is provided with a guiding groove, and the projection is arranged to be slidable in the guiding groove. When the trigger 30 moves between the first position and the second position, the projection slides along the guiding groove, thereby ensuring that the trigger 30 can slide stably between the first position and the second position along the guiding groove.

In some embodiment, as shown in FIG. 5, the bottom leg 20 includes a foundation member 210 and a cushioning member 220. The foundation member 210 is fixedly connected to the second end portion 102 of the support leg body 10, and the guiding post 60 and the foundation member 210 are an integral structure. The cushioning member 220 is attached to the foundation member 210, and the cushioning member 220 has a contacting-floor surface 201. When the trigger 30 is in the first position, at least a portion of the trigger protrudes from the contacting-floor surface 201. By designing the guiding post 60 and the foundation member 210 to be the integral structure, the strength of the connection between the guiding post 60 and the foundation member 210 can be increased, and the movement direction of the trigger 30 is prevented from being affected by the inclination of the guiding post 60 during the movement of the trigger 30.

In some embodiment, the triggering part 320 of the trigger 30 is movable and arranged to pass through the opening 111 of the fixing member 110, and the opening also serves as a guide. The accuracy of the direction of movement of the trigger 30 is ensured by the dual guidance of the guiding post 60 and of the opening 111.

In some embodiment, the cushioning member 220 is made of a thermoplastic elastomer (TPE, also known as artificial rubber or synthetic rubber). The thermoplastic elastomer has the advantages of both rubber and plastic. Specifically, the TPE has high elasticity, and may increase the friction force to prevent the support device from sliding, and has low cost.

As shown in FIGS. 3-4, and 6-7, the support device 100 of an embodiment of the present disclosure further includes a support member 70. The support member 70 is disposed in the support leg body 10 and connected to the support leg body 10. In some embodiment, the support member 70 is disposed in the first leg tube 1 and the second leg tube 2, and is fixedly connected to the first leg tube 1. In some embodiment, the alarm unit 40 further includes a wire 430, which is disposed inside the support leg body 10 and connected to the support member 70. The wireless module 420 is disposed outside the support leg body 10 and is connected to the switch module 410 via the wire 430. In some embodiment, the wireless module 420 is disposed on the base 200.

By connecting the wire 430 to the support member 70, the wire 430 may be prevented from being wound during the extension or retraction of the second leg tube 2 with respect to the first leg tube 1.

In some embodiment, the support member 70 is a bar-shaped structure. One end of the bar-shaped structure is fixedly connected to the top of the first leg tube 1, and the other end of the bar-shaped structure extends toward the bottom leg 20. The bar-shaped structure is arranged to be hung on the top of the first leg tube 1.

In some embodiment, the support member 70 further includes a plurality of support portions. The plurality of support portions is arranged along the direction of extension or retraction of the first leg tube 1 and the second leg tube 2, and each of the support portions is connected to the wire 430. The support portions are arranged at equal intervals or are arranged at unequal intervals.

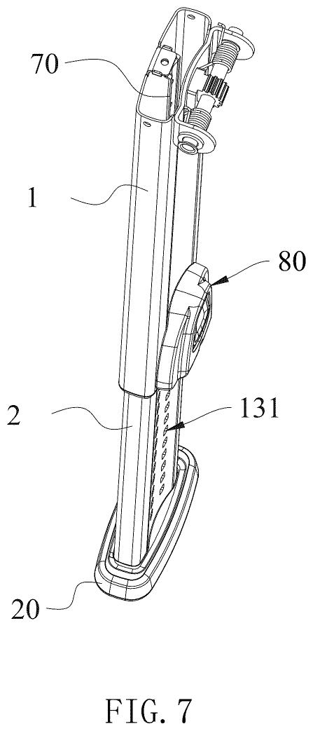

FIG. 7 shows a perspective view of the support device according to an embodiment of the present disclosure. As shown in FIG. 7, the support device 100 further includes a locking structure 80. The locking structure 80 is connected to the first leg tube 1 and connected to the second leg tube 2, and is configured to lock the first leg tube 1 and the second leg tube 2 to keep a target length of the support leg body 10.

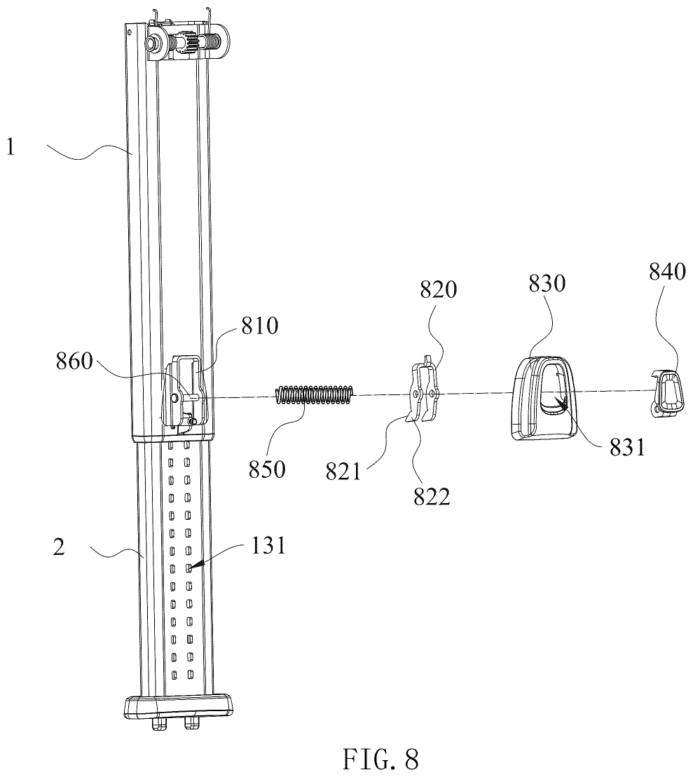

FIG. 8 shows an exploded schematic view of the locking structure. As shown in FIG. 8, the locking structure 80 includes a first engaging member 820 and a restoring member 850. The first engaging member 820 is rotatable with respect to the first leg tube 1. The second leg tube 2 is provided with a plurality of locking holes 131, and the plurality of locking holes 131 is arranged along the direction of extension or retraction of the first leg tube 1 and the second leg tube 2. The restoring member 850 is connected between the first leg tube 1 and the first engaging member 820, and configured to provide an elastic force for the first engaging member 820. The elastic force is capable of driving the first engaging member 820 to enter the locking hole 131. As a specific example, the first engaging member 820 includes an engaging hook 822 configured to selectively extend into any locking hole 131. The second leg tube 2 is locked in different positions by the engaging hook 822 extending into different locking holes 131, thereby realizing an adjustment of the length of the support leg body 10, so that the support device 100 may be adapted to vehicles of different types.

The engaging hook 822 has a guiding ramp 821. The guiding ramp 821 is arranged to face the locking hole 131 and is gradually inclined toward the side close to the second leg tube 2 along the extension direction of the second leg tube 2. When the user needs to lengthen the support leg body 10, the user may pull down the second leg tube 2 directly. The engaging hook 822 disengages from the locking hole 131 under the guidance of the guiding ramp 821, so that the user may lengthen the support leg body 10 directly without pressing the first engaging member 820.

The locking structure 80 further includes a bracket 810, a fixing cover 830, and a first button 840. The bracket 810 is fixedly attached to an outer wall surface of the first leg tube 1, for example, the bracket 810 is welded on the first leg tube 1. The first engaging member 820 is rotatably connected to the bracket 810 by a rotating shaft 860. The fixing cover 830 is attached to the bracket 810 and covers the first engaging member 820 and the restoring member 850. The fixing cover 830 is provided with a window 831 through which part of the first engaging member 820 is exposed to the outer surface of the fixing cover 830. The first button 840 is connected to the first engaging member 820 through the window 831. When the support leg body 10 needs to be shortened, the user presses the first button 840, then the first button 840 drives the first engaging member 820 to rotate, so that the engaging hook 822 disengages from the locking hole 131. When the target length is achieved, the user releases the first button 840, and under the elastic force of the restoring member 850, the engaging hook 822 of the first engaging member 820 extends into one of the locking holes 131, thereby realizing the lock.

For example, the restoring member 850 may include, but is not limited to, a spring.

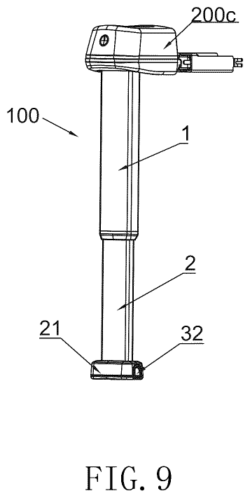

FIGS. 9 to 13 schematically show a structure of a support device 100 according to some embodiment of the present disclosure. The support device 100 is described in the present embodiment by taking an example of the support device applied to a child safety seat. More specifically, referring to FIG. 9, the upper end of the support device 100 is pivotally connected to a pivot seat 200c disposed at the front end of the base of the child safety seat. The seat and the main part of the base of the child safety seat are not shown in FIG. 9, and only the pivot seat 200c disposed at the front end of the base and arranged to be connected with the support device 100 is illustrated. It should be understood that the support device 100 is configured to be applied but not limited to the child safety seats, and it may be applied to any suitable product.

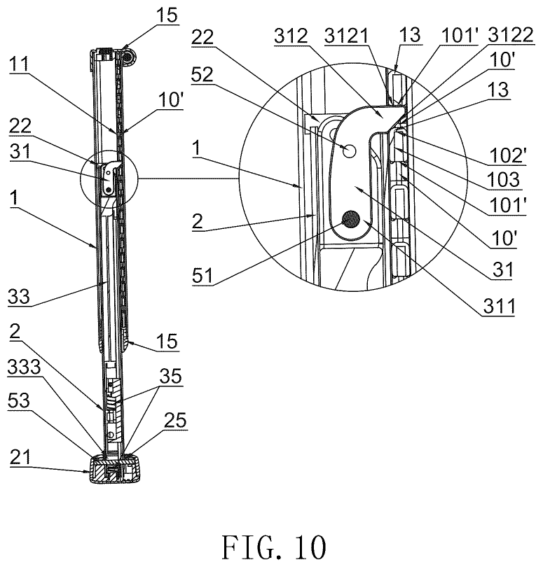

Referring to FIGS. 9 to 12, the support device 100 includes at least a first leg tube 1, a second leg tube 2, and a locking device 3. A plurality of first positioning holes 10′ are disposed on the side wall of the first leg tube 1 along the height direction, and the number of the first positioning holes 10′ is two or more as shown in the figure. The second leg tube 2 is slidably sleeved in the first leg tube 1. A first end (a lower end in the figure) of the second leg tube 2 is disposed outside the first leg tube 1 and is provided with a bottom leg 21 for increasing a contact area between the support device 100 and the floor, thereby increasing a frictional force therebetween. A second end (upper end in the figure) of the second leg tube 2 is disposed inside the first leg tube 1. The locking device 3 is mounted on the second leg tube 2 and has a second engaging member 31. The second engaging member 31 is configured to be in a locked position (FIG. 10), where the second engaging member 31 extends into a corresponding first positioning hole 10′ and engages with the corresponding first positioning hole 10′; the second engaging member 31 is configured to be in an unlocked position (not shown in the figure), where the second engaging member 31 disengages from the first positioning hole 10′. It should be understood that when the length of the support device 100 needs to be adjusted, the second engaging member 31 is switched to the unlocked position, so that the second leg tube 2 is allowed to slide freely with respect to the first leg tube 1. When the length of the support device 100 is adjusted, the second engaging member 31 is switched to the locked position, then the second leg tube 2 will not able to slide freely with respect to the first leg tube 1, so that the support device 100 is locked and have the adjusted length. In this embodiment, the first leg tube 1, the second leg tube 2, and the second engaging member 31 each are made of, for example, a metallic material. In other embodiments, the first leg tube 1, the second leg tube 2, and the second engaging member 31 each are made of other suitable material.

In the embodiments of the present disclosure, the height direction refers to the height direction of the support device 100 in use. Referring to FIGS. 9 to 11 and FIG. 13, in the present embodiment, the upper end of the first leg tube 1 and the pivot seat 200c are pivotally connected. The second end of the second leg tube 2 extends from the lower end of the first leg tube 1 to the inside of the first leg tube 1, and the second engaging member 31 is also disposed inside the first leg tube 1. The inner side wall of the side wall body of the first leg tube 1 is further provided with a bar-shaped adjustment member 11, and the first positioning holes 10′ is disposed in the bar-shaped adjustment member 11. The bar-shaped adjustment member 11 is fixed on the inner side wall of the side wall body of the first leg tube 1 by any suitable means. For example, in the present embodiment, the length of the bar-shaped adjustment member 11 is substantially equal to the length of the first leg tube 1. Stoppers 15 are mounted at two ends of the first leg tube 1, respectively. Two ends of the bar-shaped adjustment member 11 are connected to the stoppers 15, respectively. In some alternative embodiments, the bar-shaped adjustment member 11 is directly connected to the side wall body of the first leg tube 1, for example, by a fastener. In the present embodiment, the first positioning holes 10′ are disposed on the bar-shaped adjustment member 11, and the side wall body of the first leg tube 1 shields the first positioning holes 10′ from the outside, so that foreign things may be prevented from entering the first leg tube 1 through the first positioning holes 10′.

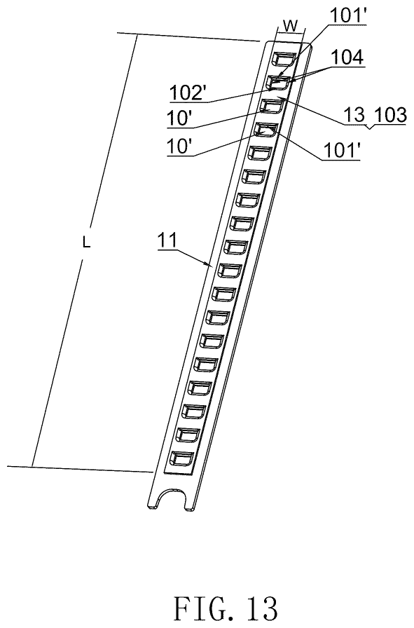

Referring to FIG. 13, in the present embodiment, the bar-shaped adjustment member 11 is made of a metallic material, and at least a partial area of the bar-shaped adjustment member 11 is covered with a third cushioning layer 13, which is fixed to the bar-shaped adjustment member 11 by a cover molding process, by adhering, or by other means. For example, when the second engaging member 31 collides with the first leg tube 1 during the slide of the second leg tube 2, the second engaging member 31 is in direct contact with the third cushioning layer 13. The third cushioning layer 13, as a cushioning member, may effectively reduce the noise generated by the collision of the second engaging member 31 and the first leg tube 1 during the length adjustment of the support device 100.

The third cushioning layer 13 may be any material layer capable of cushioning collision and reducing noise, such as a plastic clad layer, a plastic-steel clad layer, or a nylon clad layer. The third cushioning layer 13 covers at least a region, which corresponds to the movement track of the second engaging member 31, and where the plurality of first positioning holes 10′ are disposed. During the slide of the second leg tube 2, the engaging portion of the second engaging member 31 (referring to a second end 312 of the second engaging member 31 as a specific example in some embodiment below), which is configured to extend into the first positioning hole 10′, relatively frequently collides with the first leg tube 1, and the movement track of the engaging portion corresponds to the region where the plurality of first positioning holes 10′ are located. Therefore, in some embodiment, the third cushioning layer 13 is arranged only in the area where the bar-shaped adjustment member 11 relatively frequently collides with the second engaging member 31, and the noise reduction effect is obtained at a lower cost. Referring to FIG. 13, the third cushioning layer 13 is arranged, for example, in the region of a length L and a width W. The third cushioning layer 13 surrounds the plurality of first positioning holes 10′, so that the stability of the attachment between the third cushioning layer 13 and the bar-shaped adjustment member 11 is also ensured. In some embodiments, the third cushioning layer 13 covers the entire bar-shaped adjustment member 11. In other embodiments, the bar-shaped adjustment member 11 is directly made of a cushioning material including, but not limited to, plastic, nylon, plastic-steel, and the like, while ensuring structural strength of the bar-shaped adjustment member 11.

Referring to FIGS. 10 and 13, in some embodiment, each first positioning hole 10′ includes an abutted wall 101′, and a bottom wall 102′ opposite to the abutted wall 101′. When the second engaging member 31 is in the locked position, the second engaging member 31 abuts against the abutted wall 101′ to lock the position of the second leg tube 2 with respect to the first leg tube 1, so that the desired length of the support device 100 can be obtained. It should be understood that, compared with any other portion of the bar-shaped adjustment member 11, the abutted wall 101′ is subjected to a greater stress exerted by the second engaging member 31 when abutting against the second engaging member 31. In order to ensure the engagement strength between the second engaging member 31 on the second leg tube 2 and the first positioning hole 10′ in the bar-shaped adjustment member 11, and ensure that the lock of the second leg tube 2 with respect to the first leg tube 1 will not loosen when the support device 100 is pressed by the seat and the main body of the base of the child safety seat and subjected to the reaction force from the inner floor of the vehicle. The abutted wall 101′ is not covered with the third cushioning layer 13. In this case, the situation, which the third cushioning layer 13 at the abutted wall 101′ breaks under stress to affect the attachment stability between the third cushioning layer 13 and the bar-shaped adjustment member 11, may be avoided.

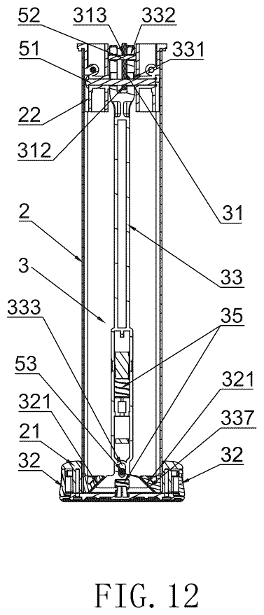

In the present embodiment, the second engaging member 31 is switched between the locked position and the unlocked position in a rotating manner. Referring to FIGS. 10 and 12, in some embodiment, a positioning member 22 is mounted at the second end of the second leg tube 2. A first end 311 of the second engaging member 31 is rotatably connected to the positioning member 22 through a first shaft 51, and a second end 312 of the second engaging member 31 (namely the above-mentioned engaging portion) is configured to engage with or disengage from the corresponding first positioning hole 10′. For the support device 100 applied to the child safety seat of some embodiment, the second end 312 of the second engaging member 31 is in a shape of a locking tongue. The second end 312 has a horizontal plane region 3121 for abutting against the abutted wall 101′ (namely, a top wall of the first positioning hole 10′ in FIG. 10) of the first positioning hole 10′, and has an inclined plane region 3122 facing away from the abutted wall 101′. The inclined plane region 3122 allows the second leg tube 2 to be pulled outwards from the first leg tube 1 when the locking device 3 needs not to be locked. The second engaging member 31 is configured to prevent the retraction movement of the second leg tube 2 into the first leg tube 1 but not prevent the extension movement of the second leg tube 2 out of the first leg tube 1. That is, the second leg tube 2 is locked by the second engaging member 31 unidirectionally.

Referring again to FIG. 10, when the second engaging member 31 is in the locked position, the horizontal plane region 3121 of the second engaging member 31 abuts against the portion of the first positioning hole 10′ not covered with the third cushioning layer 13, more specifically, abuts against the abutted wall 101′, and the inclined plane region 3122 of the second engaging member 31 faces the bottom wall 102′ of the first positioning hole 10′. The third cushioning layer 13 covers the bottom wall 102′ and an inner side wall 103 of the bar-shaped adjustment member 11 extending downward from the bottom wall 102′. Where, the inner side wall 103 corresponds to the movement track of the second end 312 of the second engaging member 31. It should be understood that when the second engaging member 31 rotates to the locked position, the inclined plane region 3122 is prone to collide with an interface between the bottom wall 102′ and the inner side wall 103. When the second leg tube 2 extends outwards from the first leg tube 1, the second engaging member 31 rotates to the unlocked position, and the inclined plane region 3122 will slide along the interface between the bottom wall 102′ and the inner side wall 103 and slide along the inner side wall 103. In the present embodiment, the third cushioning layer 13 covers the bottom wall 102′ and the inner side wall 103. When the second leg tube 2 is pulled outwards from the first leg tube 1, the inclined plane region 3122 of the second engaging member 31 is in contact with the bottom wall 102′ and the inner side wall 103 of the bar-shaped adjustment member 11 by means of the third cushioning layer 13. The third cushioning layer 13 can effectively cushion the collision and the relative slide between a region, which includes the inclined plane region 3122 of the second engaging member 31 and a transition surface between the inclined plane region 3122 and the horizontal plane region 3121, and the bar-shaped adjustment member 11, thereby reducing noises including collision noise and friction noise generated during the length adjustment of the support device 100.

Referring to FIG. 13, the first positioning hole 10′ includes a top wall (i.e., the abutted wall 101′), the bottom wall 102′, and two side walls 104. In the above-described embodiment, the third cushioning layer 13 does not cover the top wall (i.e., the abutted wall 101′) of the first positioning hole 10′ but cover the bottom wall 102′ of the first positioning hole 10′. In an embodiment, the third cushioning layer 13 further covers the two side walls 104 of the first positioning hole 10′. In some embodiments, the third cushioning layer 13 also cover the abutted wall 101′.

In a state of the locking device 3, the second engaging member 31 is kept in the locking position. There are many implementations of the locking device 3, and some embodiments of the locking device 3 hereinafter are exemplary.

Referring to FIGS. 10 to 12, in some embodiment, the locking device 3 further includes an operating button 32, a traction member 33 and a second elastic restoring member 35. The operating button 32 is mounted on the bottom leg 21. The traction member 33 and the second elastic restoring member 35 are disposed inside the second leg tube 2. When a pressing force is applied to the operating button 32 in an initial position, the pressed operating button 32 drives the second engaging member 31 by means of the traction member 33, and the second engaging member 31 is driven to rotate around the first shaft 51 from the locked position to the unlocked position. When the pressing force applied to the operating button 32 is removed, the second elastic restoring member 35 directly or indirectly drives the second engaging member 31 to rotate around the first shaft 51 from the unlocked position to the locked position, and the operating button 32 is correspondingly restored to the initial position.

Referring to FIG. 12, in the embodiment, the traction member 33 may be a rod member and is adapted for moving up and down in the height direction of the second leg tube 2. The movement direction of the operating button 32 is perpendicular to the height direction of the second leg tube 2, and a first end (a lower end in the figure) of the operating button 32 abuts against a second inclined surface 337 of a first end of the traction member 33 through a first inclined surface 321. When the operating button 32 is pressed, the pressing of the operating button 32 is converted into a downward movement of the traction member 33 under the action of the first inclined surface 321 and the second inclined surface 337, thereby driving the second engaging member 31 to rotate toward the unlocked position. The second elastic restoring member 35 may be one or more springs for applying an upward elastic force to the traction member 33. Once the pressing force applied to the operating button 32 is removed, the second elastic restoring member 35 drives the traction member 33 to move upward, thereby driving the second engaging member 31 to rotate toward the locked position. At the same time, under the action of the first inclined surface 321 and the second inclined surface 337, the upward movement of the traction member 33 is converted into a restoring movement of the operating button 32. It should be understood that, in the embodiment, the operating button 32 abuts against the traction member 33 through the first inclined surface 321 and the second inclined surface 337 which cooperate with each other, but in other embodiments, only one of the operating button 32 and the traction member 33 shall be provided with an inclined surface for abutting against the other. In addition, in some embodiments, a spring for restoring the operating button 32 may be further arranged at the operating button 32.

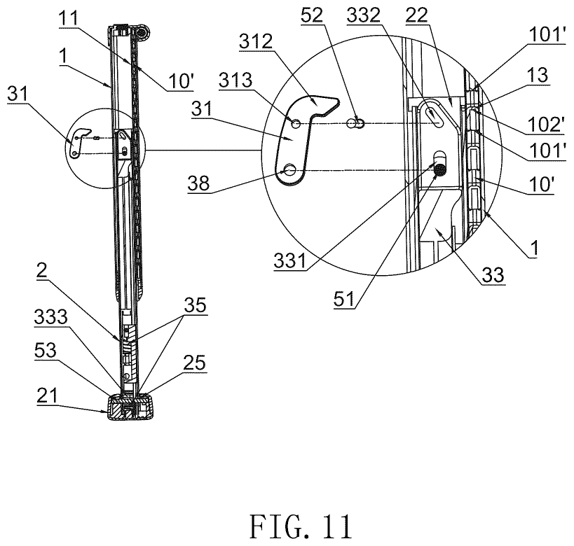

Referring to FIGS. 11 and 12, examples for guiding the up-and-down movement of the traction member 33 are shown in this embodiment. Specifically, a first long hole 331 extending in the height direction of the traction member 33 is disposed at a second end (an upper end in the figure) of the traction member 33. The first shaft 51 slidably engages with the first long hole 331, and the first shaft 51 passes through a second circular hole 38 of the second engaging member 31. A third long hole 333 extending in the height direction of the traction member 33 is disposed at a first end (the lower end in the figure) of the traction member 33, A third shaft 53 slidably engages with the third long hole 333 is disposed in the third long hole 333, and the third shaft 53 is mounted in a first circular hole 25 of the second leg tube 2. Of course, the manners of the axial movement of the traction member 33 are not limited to the above-mentioned examples.

Referring to FIG. 11, an example of the traction member 33 for driving the second engaging member 31 to rotate is shown in the embodiment. The second end of the traction member 33 is provided with a second long hole 332 extending obliquely, and the second long hole 332 is located above the first long hole 331. The second engaging member 31 is provided with a second positioning hole 313, which is located above the second circular hole 38. A second shaft 52 is mounted in the second long hole 332 and the second positioning hole 313. When the position of the second leg tube 2 needs to be adjusted, the operating button 32 is pressed to drive the traction member 33 to move downwards, and the second shaft 52 slides relative to the second long hole 332, so that the second engaging member 31 rotates around the first shaft 51 from the locked position to the unlocked position, and that the second end 312 of the second engaging member 31 disengages from the first positioning hole 10′, thereby allowing the second leg tube 2 to slide freely. When the second leg tube 2 slides to a proper position, the pressing force applied to the operating button 32 is removed, the second elastic restoring member 35 drives the traction member 33 to move upwards, the second shaft 52 slides relative to the second long hole 332, so that the second engaging member 31 rotates around the first shaft 51 from the unlocked position to the locked position, and that the second end 312 of the second engaging member 31 extends into the first positioning hole 10′ again to engage with the first positioning hole 10′, thereby preventing the second leg tube 2 from retracting into the first leg tube 1, and ensuring the supported height of the support device 2. It should be understood that in some alternative embodiments, the position of the second long hole 332 on the traction member 33 and the position of the second positioning hole 313 on the second engaging member 31 may exchange with each other.

It should be understood that the locking device 3, configured to realize the switching of the second engaging member 31 between the locked position and the unlocked position through rotation, is not limited to the above examples. For example, in some alternative embodiments, the traction member 33 may include a flexible cable connected to the second engaging member 31. The flexible cable may be driven by the operating button 32 to pull the second engaging member 31 to rotate to the unlocked position, and the second elastic restoring member 35 may be a torsion spring which drives the second engaging member 31 to rotate to the locked position.

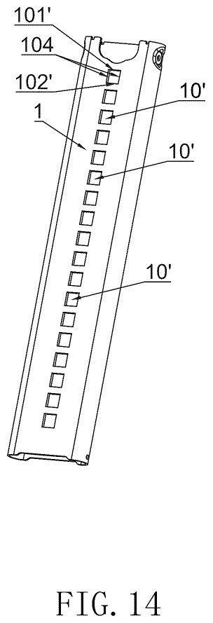

FIG. 14 schematically shows a perspective view of a first leg tube 1 of the support device 100 according to some embodiment of the present disclosure. The present embodiment in FIG. 14 differs from the embodiment described above in that the first positioning holes 10′ may be directly formed on the side wall body of the first leg tube 1. More specifically, the plurality of first positioning holes 10′ may be arranged to pass through the side wall body of the first leg tube 1 to form a plurality of through holes arranged in the height direction of the first leg tube 1. The first leg tube 1 is made of, e.g., metal. At least part of the area of the inner side wall of the side wall body of the first leg tube 1 is covered with a second cushioning layer. The second cushioning layer may be fixed to the inner side wall of the first leg tube 1 by a cover molding process, by adhering, or by other means. When the second engaging member 31 collides with the inner side wall of the first leg tube 1 during the slide of the second leg tube 2, the second engaging member 31 is in direct contact with the second cushioning layer. The second cushioning layer, as a cushioning member, may effectively reduce the noise generated by the collision of the second engaging member 31 and the inner side wall of the first leg tube 1 during the length adjustment of the support device 100. The second cushioning layer may be any material layer capable of cushioning collision and reducing noise, such as a plastic clad layer, a plastic-steel clad layer, or a nylon clad layer.

Similar to the embodiment shown in FIGS. 9 to 13, in the embodiment in FIG. 14, the second cushioning layer covers at least a region, which corresponds to the movement track of the second engaging member 31, and where the plurality of first positioning holes 10′ are disposed. That is, the second cushioning layer is provided in the region of the side wall body of the first leg tube 1, which the second end 312 of the second engaging member 31 collides with easily and slides with respect to. The second cushioning layer, for example, surrounds the plurality of first positioning holes 10′ therein.

Referring to the description of the embodiment described above, in the embodiment in FIG. 14, the second end 312 of the second engaging member 31 is in the shape of a locking tongue, and the top wall (i.e., the abutted wall 101′) of each first positioning hole 10′ is configured to abut against the horizontal plane region 3121 of the second engaging member 31, so as to lock the position of the second leg tube 2 with respect to the first leg tube 1. The abutted wall 101′ may not be covered with the second cushioning layer. The bottom wall 102′ of each first positioning hole 10′ opposite to the abutted wall 101′, and the inner side wall (not numbered) of the side wall body of the first leg tube I extending downwards from the bottom wall 102′, may be covered with the second cushioning layer. When the second leg tube 2 is pulled outwards from the first leg tube 1, the inclined plane region 3122 of the second engaging member 31 is in contact with the bottom wall 102′ and in contact with the inner side wall of the side wall body of the first leg tube 1 by means of the second cushioning layer 13. The second cushioning layer can effectively cushion the collision and the relative sliding between a region, which includes the inclined plane region 3122 of the second engaging member 31 and a transition surface between the inclined plane region 3122 and the horizontal plane region 3121, and the inner side wall of the first leg tube 1, thereby reducing noise of the support device 100 during the length adjustment. In an embodiment, the second cushioning layer may also cover the two side walls 104 of each of the first positioning holes 10′. However, in some embodiments, the second cushioning layer may also cover the abutted wall 101 of each of the first positioning holes 10′.

The present disclosure also provides an embodiment (not shown in figures) of the support device 100. Based on the embodiments described above, in the embodiment, the first cushioning layer may cover the second engaging member 31 made of metal. The first cushioning layer may be fixed on the second engaging member 31 by a cover molding process, by adhering, or by other means. In an embodiment, the first cushioning layer may completely cover or partially cover the second engaging member 31. When the second engaging member 31 collides with the first leg tube 1 during the slide of the second leg tube 2, the second engaging member 31 is in contact with the third cushioning layer 13 on the bar-shaped adjustment member 11 or the second cushioning layer on the first leg tube 1 by means of the first cushioning layer. The first cushioning layer, together with other cushioning layers, as a cushioning member, may cushion the collision, and reduce collision noise and friction noise. The first cushioning layer may be any material layer capable of cushioning collision and reducing noise, such as a plastic clad layer, a plastic-steel clad layer, or a nylon clad layer.

In an embodiment, the part of the second engaging member 31, which is in contact with the abutted wall 101′ of the first positioning hole 10′, may not be covered with the first cushioning layer, so as to prevent the first cushioning layer from breaking after being subjected to a stress, and avoid affecting the attachment stability between the first cushioning layer and the second engaging member 31.

In some alternative embodiments, while ensuring structural strength of the second engaging member 31, the second engaging member 31 may be made directly from a cushioning material including, but not limited to, plastic, nylon, plastic-steel, and the like.

It should be understood that, in some alternative embodiments, when the second engaging member 31 has the first cushioning layer or the second engaging member 31 is made from the cushioning material, the collision noise and the friction noise between the second engaging member 31 and the first leg tube 1 may be reduced even if no cushioning layer is arranged on the bar-shaped adjustment member 11 or on the inner side wall of the first leg tube 1.

It should be understood that although the second engaging member 31 in the above embodiments of the present disclosure is switched between the locked position and the unlocked position in a rotating manner, in other embodiments, the second engaging member 31 (for example, a latch) may be switched between the locked position and the unlocked position in a manner of linear movement. The locking device for realizing the linear movement of the second engaging member 31 is known in the prior art and will not be described herein. It should be understood that the cushioning member described in the embodiment of the present disclosure may be arranged on the inner side wall of the first leg tube 1 and/or the second engaging member 31, to reduce the collision noise and the friction noise generated by the second engaging member 31 and the first leg tube 1 during the slide of the second leg tube 2 by means of the cushioning member, regardless of the manner in which the second engaging member 31 is switched between the locked position and the unlocked position

An embodiment of the present disclosure also provides a child safety seat. A front end of a base of the child safety seat is mounted with the support device provided in any of the previous embodiments. In an embodiment, the first leg tube 1 may be connected to the pivot seat 200c at the front end of the base, as previously described.

The embodiments of the present disclosure provide the child safety seat and the support device thereof. A floor contact state of the support device can be accurately acquired in time, and the user can monitor a position change of the support device in real time, thereby effectively improving the safety of the safety seat.

The support device provided by the embodiments of the present disclosure can improve the problem of the noise of the support device during the length adjustment in the prior art.

In one aspect, an embodiment of the present disclosure provides a support device applied to a child safety seat. The support device includes a support leg body, a bottom leg, a trigger, and an alarm unit. The bottom leg is connected to a bottom end of the support leg body, and the bottom leg and the support leg body forms a receiving space. The trigger is movably connected to the bottom leg. The trigger is movable between a first position and a second position. In the first position, at least a portion of the trigger protrudes from the bottom leg, and in the second position, the trigger is received in the receiving space. The alarm unit includes a switch module and a wireless module. The switch module is configured to acquire a floor contact signal indicating that the trigger is in the second position, and the wireless module is in signal communication with the switch module.

According to some embodiments of the present disclosure, the trigger is movably connected to the bottom leg, and the trigger is movable in a height direction of the support leg body.

According to some embodiments of the present disclosure, a fixing member is fixedly disposed inside the support leg body, and the switch module is connected to the fixing member. The fixing member is arranged to be opposite to the trigger in a height direction of the support leg body.

According to some embodiments of the present disclosure, the support device further includes a first elastic restoring member.

An end of the first elastic restoring member is arranged to abut against the trigger; and another end of the first elastic restoring member is arranged to abut against the fixing member. The first elastic restoring member is configured to apply an elastic force to the trigger to drive the trigger to move towards the first position.

According to some embodiments of the present disclosure, the fixing member has an opening, and the trigger is movably arranged to pass through the opening.

According to some embodiments of the present disclosure, the bottom leg includes:
a foundation member, connected to the support leg body, and
a cushioning member, attached to the foundation member, and having a contacting-floor surface. When the trigger is in the first position, at least a portion of the trigger protrudes from the contacting-floor surface.

According to some embodiments of the present disclosure, the support leg body comprises a first leg tube and a second leg tube, and the first leg tube and the second leg tube are connected in an extendable and retractable manner.

The support device further comprises a support member, and the support member is disposed in the first leg tube and the second leg tube, and fixedly connected to the first leg tube.

According to some embodiments of the present disclosure, the alarm unit further includes a wire, the wireless module is connected to the switch module through the wire, and the wire is disposed inside the support leg body and connected to the support member.

According to some embodiments of the present disclosure, the switch module includes a circuit board and a switch.

The circuit board is embedded in the fixing member and is in communication with the wireless module.

The switch is mechanically and electrically connected to the circuit board, and includes a switch body and a contact terminal connected to the switch body.

According to some embodiments of the present disclosure, the trigger includes:
a base body, disposed on a side of the bottom leg facing the support leg body;
a triggering part, attached to a side of the base body facing the fixing member, and configured to force the contact terminal to abut against a side surface of the triggering part when the trigger is in the second position; and
a contacting-floor part, attached to a side of the base body away from the fixing member, and movably arranged to pass through through holes in the bottom leg.

According to some embodiments of the present disclosure, a guiding hole is disposed on the base body; and
a guiding post is disposed between the fixing member and the bottom leg, and the guiding post extends along the height direction of the support leg body, and the guiding post is slidably arranged to pass through the guiding hole.

According to some embodiments of the present disclosure, an end of the guiding post is connected to the side of the bottom leg facing the support leg body, and another end of the guiding post is fixedly connected to a side of the fixing member adjacent to the bottom leg.

According to some embodiments of the present disclosure, the bottom leg includes a foundation member and a cushioning member.

The foundation member is connected to the support leg body.

The cushioning member is attached to the foundation member, and has a contacting-floor surface.

When the trigger is in the first position, at least a portion of the trigger protrudes from the contacting-floor surface.

The guiding post and the foundation member are in an integral structure.

According to some embodiments of the present disclosure, an inner wall of the second leg tube is provided with a guiding groove.

The trigger is provided with a projection, and the projection is arranged to be slidable in the guiding groove.

According to some embodiments of the present disclosure, the support leg body comprises a first leg tube and a second leg tube, and the first leg tube and the second leg tube are connected in an extendable and retractable manner.

The second leg tube is provided with a plurality of locking holes arranged along a direction of extension or retraction of the first leg tube and the second leg tube.

The support device further comprises a locking structure, and the locking structure is connected to the first leg tube and the second leg tube and includes a first engaging member and a restoring member.

The first engaging member is rotatably arranged relative to the first leg tube.

The restoring member is connected between the first leg tube and the first engaging member, and configured to provide an elastic force for the first engaging member to extend into any one of the plurality of locking holes.

According to some embodiments of the present disclosure, the first engaging member includes an engaging hook configured to selectively extend into any one of the plurality of locking holes.

The engaging hook has a guiding ramp, the guiding ramp is arranged to face any one of the plurality of locking holes and is gradually inclined toward a side close to the second leg tube along an extension direction of the second leg tube.

According to some embodiments of the present disclosure, the locking structure further includes a bracket, a fixing cover, and a first button.

The bracket is fixedly connected to the first leg tube. The first engaging member is rotatably connected to the bracket by a rotating shaft.

The fixing cover is connected to the bracket and configured to cover the first engaging member and the restoring member. The fixing cover is provided with a window through which part of the first engaging member is exposed to an outer surface of the fixing cover.

The first button is connected to the first engaging member through the window.

In another aspect, an embodiment of the present disclosure provides a support device including: a first leg tube, provided with a plurality of first positioning holes in a height direction of the first leg tube; a second leg tube, slidably sleeved in the first leg tube; a locking device mounted on the second leg tube and having a second engaging member, where, the second engaging member is configured to move between a locked position and an unlocked position, and in the locked position, the second engaging member engages with a corresponding positioning hole, and in the unlocked position, the second engaging member disengages from the corresponding positioning hole; and a cushioning member, provided on at least one of an inner side wall of the first leg tube and the second engaging member, for cushioning a collision between the second engaging member and the first leg tube during sliding of the second leg tube.

In an embodiment, the cushioning member includes a first cushioning layer covering the second engaging member, or the second engaging member is made from a cushioning material and forms the cushioning member.

In an embodiment, the plurality of first positioning holes are formed on a side wall body of the first leg tube. The cushioning member includes a second cushioning layer covering partial area of an inner side wall of the side wall body of the first leg tube. The partial area comprises a region, which corresponds to a movement track of the second engaging member, and where the plurality of first positioning holes are disposed.

In an embodiment, the first leg tube is made of metal, each of the plurality of first positioning holes comprises an abutted wall. The abutted wall is not covered with the second cushioning layer, and is configured to abut against the second engaging member.

In an embodiment, each of the plurality of first positioning holes includes a bottom wall opposite to the abutted wall. the second engaging member is provided with an engaging portion configured to extend into the corresponding first positioning hole, the engaging portion is in a shape of a locking tongue, and the engaging portion comprises a horizontal plane region and an inclined plane region. When the second engaging member is in the locked position, the horizontal plane region is in contact with the abutted wall, and the inclined plane region faces the bottom wall. When the second leg tube is being pulled outwards from the first leg tube, the inclined plane region is in contact with the bottom wall and the inner side wall of the first leg tube through the second cushioning layer.

In an embodiment, the inner side wall of the side wall body of the first leg tube is provided with a bar-shaped adjustment member, and the plurality of first positioning holes are disposed in the bar-shaped adjustment member. The cushioning member comprises a third cushioning layer covering a partial area of the bar-shaped adjustment member, wherein the partial area comprises a region, which corresponds to a movement track of the second engaging member, and where the plurality of first positioning holes are disposed.

In an embodiment, the bar-shaped adjustment member is made of metal, each of the plurality of first positioning holes includes an abutted wall. The abutted wall is not covered with the second cushioning layer, and is configured to abut against the second engaging member to lock a position of the second leg tube.

In an embodiment, each of the plurality of first positioning holes includes a bottom wall opposite to the abutted wall. the second engaging member is provided with an engaging portion configured to extend into the corresponding first positioning hole, the engaging portion is in a shape of a locking tongue, and the engaging portion comprises a horizontal plane region and an inclined plane region. When the second engaging member is in the locked position, the horizontal plane region is in contact with the abutted wall, and the inclined plane region faces the bottom wall. When the second leg tube is being pulled outwards from the first leg tube, the inclined plane region is in contact with the bottom wall and an inner side wall of the bar-shaped adjustment member through the third cushioning layer.

In an embodiment, the bar-shaped adjustment member is made of a cushioning material and forms the cushioning member.

In an embodiment, the second engaging member is switched between the locked position and the unlocked position by rotating or moving linearly.

In an embodiment, a first end of the second leg tube is disposed outside the first leg tube, and a second end of the second leg tube is disposed inside the first leg tube and provided with a positioning member. A first end of the second engaging member is rotatably connected to the positioning member through a first shaft, and a second end of the second engaging member is configured to engage with or disengage from the corresponding first positioning hole.

In an embodiment, the first end of the second leg tube is provided with a bottom leg. The locking device further includes an operating button mounted on the bottom leg, a traction member, and a second elastic restoring member. The operating button is disposed on the bottom leg, the traction member and the second elastic restoring member are disposed inside the second leg tube. The operating button is arranged to, through the traction member, drive the second engaging member to rotate from the locked position to the unlocked position. The second elastic restoring member is configured to drive the second engaging member to rotate from the unlocked position to the locked position.

In an embodiment, the traction member is a rod member. The operating button abuts against a first end of the traction member through a first inclined surface. A first long hole extending in a height direction of the traction member is disposed at a second end of the traction member, and the first shaft slidably engages with the first long hole. Among a second end of the traction member and the second engaging member, one is provided with a second long hole extending obliquely, another is provided with a second positioning hole. A second shaft is disposed in the second long hole and the second positioning hole.

In still another aspect, an embodiment of the present disclosure provides a child safety seat. A front end of a base of the child safety seat is provided with the support device described above, and the first leg tube of the support device is connected to the front end of the base.

According to some embodiments of the present disclosure, the wireless module of the support device is disposed on the base.

The embodiments of the above present disclosure have at least the following advantages or beneficial effects.

In the child safety seat of the embodiment of the present disclosure, when the support device is subjected to the pressing force in the height direction, since at least a portion of the trigger protrudes from the bottom leg in the first position, the trigger moves from the first position to the second position with respect to the bottom leg under the pressing force. When the trigger moves to the second position, the trigger is received in the receiving space, so that the bottom leg is in contact with the floor of the vehicle. Meanwhile, the switch module acquires the floor contact signal when the trigger is in the second position, and the wireless module, which is in signal communication with the switch module, sends the floor contact signal to the terminal, thereby realizing the real-time monitoring of the floor contact state of the support device, and avoiding the danger caused by the loosening of the support device.

Further, since at least a portion of the trigger protrudes from the bottom leg in the first position, when the support device is in contact with the floor of the vehicle, the pressing force applied to the support device directly exerts on the portion of the trigger that protrudes from the bottom leg, forcing the trigger to move from the first position to the second position until the switch module is triggered to generate a floor contact signal. The trigger moves with respect to the bottom leg more directly and flexibly, thereby avoiding the occurrence of such a situation that the trigger gets stuck to stop the switch module from acquiring the floor contact signal, thus disenabling the terminal to accurately monitor the floor contact state of the support device.

Further, a support device provided by the present disclosure uses the cushioning member to cushion the collision between the second engaging member and the first leg tube during the slide of the second leg tube, so that the noise caused by the collision can be effectively reduced, thereby improving the use experience of the consumer. When the support device is applied to the child safety seat, the adverse effects of the noise of collision, generated by the support device during the length adjustment, can be reduced for children.

It should be understood that the various embodiments/implementations provided by the present disclosure may be combined with each other if no conflicts occur, which will not be illustrated one by one herein.

In the embodiments of the present disclosure, the terms “first”, “second”, “third” are used for description only but are not to be construed as indicating or implying relative importance. The term “plurality” refers to two or more unless expressly defined otherwise. The terms “mount”, “connect”, “attach”, “fix”, and the like, should be understood in a broad sense. For example, “attach” may be to be joined to another to form a fixed attachment, a detachable attachment, or an integral attachment; and “connect” may be to be joined directly, or indirectly through an intermediate medium. The specific meanings of the above terms in the embodiments of the present disclosure should be understood by those of ordinary skill in the art based on specific circumstances.

In the description of the embodiments of the present disclosure, it should be understood that the terms “up”, “down”, “left”, “right”, “front”, “back”, etc., indicate the orientations or position relationships based on the orientations or position relationships shown in the drawings, and are used only for the convenience of describing the embodiments of the present disclosure and simplifying the description, rather than indicating or implying that a device or unit referred to must have a specific orientation, must be constructed and operated in a specific orientation, therefore they should not be construed as limitation on the embodiments of the present disclosure.

In the description of the present disclosure, the description of the terms “an embodiment”, “some embodiments”, “specific embodiments”, and the like, means that specific features, structures, materials or characteristics described in combination with the embodiment or example are included in at least one embodiment or example of the embodiments of the present disclosures. In the description, the illustrative expression of the above terms does not necessarily refer to the same embodiment or example. Furthermore, the specific features, structures, materials or characteristics described herein may be combined in a suitable manner in any one or more embodiments or examples.

What described are some embodiments of the present disclosures, but not intended to limit the embodiments of the present disclosures. For the skilled in the art, various modifications and changes may be made to the embodiments of the present disclosure. Any modifications, equivalent replacements, improvements, etc., made within the spirit and principle of the embodiments of the present disclosure shall be included within the scope of the protection of the embodiments of the present disclosure.

1. A support device, applied to a child safety seat, comprising:
a support leg body;
a bottom leg, connected to a bottom end of the support leg body, and the bottom leg and the support leg body forming a receiving space;
a trigger, movably connected to the bottom leg, the trigger being movable between a first position and a second position, wherein, in the first position, at least a portion of the trigger protrudes from the bottom leg, and in the second position, the trigger is received in the receiving space; and
an alarm unit, comprising a switch module and a wireless module, wherein the switch module is configured to acquire a floor contact signal indicating that the trigger is in the second position, and the wireless module is in signal communication with the switch module.

2. (canceled)

3. The support device according to claim 1, wherein
a fixing member is fixedly disposed inside the support leg body;
the switch module is connected to the fixing member; and
the fixing member is arranged to be opposite to the trigger in a height direction of the support leg body.

4-6. (canceled)

7. The support device according to claim 1, wherein
the support leg body comprises a first leg tube and a second leg tube, and the first leg tube and the second leg tube are connected in an extendable and retractable manner; and
the support device further comprises a support member, and the support member is disposed in the first leg tube and the second leg tube and fixedly connected to the first leg tube.

8. The support device according to claim 7, wherein
the alarm unit further comprises a wire;
the wireless module is connected to the switch module through the wire; and
the wire is disposed inside the support leg body and connected to the support member.

9. The support device according to claim 3. wherein the switch module comprises:
a circuit board, embedded in the fixing member and being in communication with the wireless module; and
a switch, mechanically and electrically connected to the circuit board, the switch comprising a switch body and a contact terminal connected to the switch body.

10. The support device according to claim 9, wherein the trigger comprises:
a base body, disposed on a side of the bottom leg facing the support leg body;
a triggering part, attached to a side of the base body facing the fixing member, and configured to force the contact terminal to abut against a side surface of the triggering part when the trigger is in the second position; and
a contacting-floor part, attached to a side of the base body away from the fixing member, and movably arranged to pass through through holes in the bottom leg.

11. The support device according to claim 10, wherein
a guiding hole is disposed on the base body; and
a guiding post is disposed between the fixing member and the bottom leg, and the guiding post extends along the height direction of the support leg body, and the guiding post is slidably arranged to pass through the guiding hole.

12. The support device according to claim 11, wherein
an end of the guiding post is connected to the side of the bottom leg facing the support leg body, and another end of the guiding post is fixedly connected to a side of the fixing member adjacent to the bottom leg.

13-17. (canceled)

18. A support device, applied to a child safety seat, comprising:
a first leg tube, provided with a plurality of first positioning holes in a height direction of the first leg tube;
a second leg tube, slidably sleeved in the first leg tube;
a locking device, mounted on the second leg tube and having a second engaging member, wherein the second engaging member is configured to move between a locked position and an unlocked position, and in the locked position, the second engaging member engages with a corresponding first positioning hole, and in the unlocked position, the second engaging member disengages from the corresponding first positioning hole; and
a cushioning member, provided on at least one of an inner side wall of the first leg tube and the second engaging member.

19. The support device according to claim 18, wherein the cushioning member comprises a first cushioning layer covering the second engaging member, or the second engaging member is made of a cushioning material and forms the cushioning member.

20. The support device according to claim 18, wherein
the plurality of first positioning holes are formed on a side wall body of the first leg tube; and
the cushioning member comprises a second cushioning layer covering partial area of an inner side wall of the side wall body of the first leg tube, wherein the partial area comprises a region, which corresponds to a movement track of the second engaging member, and where the plurality of first positioning holes are disposed.

21. The support device according to claim 20, wherein
the first leg tube is made of metal;
each of the plurality of first positioning holes comprises an abutted wall; and
the abutted wall is not covered with the second cushioning layer, and is configured to abut against the second engaging member.

22. The support device according to claim 21, wherein
each of the plurality of first positioning holes comprises a bottom wall opposite to the abutted wall;
the second engaging member is provided with an engaging portion configured to extend into the corresponding first positioning hole, the engaging portion is in a shape of a locking tongue, and the engaging portion comprises a horizontal plane region and an inclined plane region;
when the second engaging member is in the locked position, the horizontal plane region is in contact with the abutted wall, and the inclined plane region faces the bottom wall; and
when the second leg tube is being pulled outwards from the first leg tube, the inclined plane region is in contact with the bottom wall and the inner side wall of the first leg tube through the second cushioning layer.

23. The support device according to claim 18, wherein
the inner side wall of the side wall body of the first leg tube is provided with a bar-shaped adjustment member, and the plurality of first positioning holes are disposed in the bar-shaped adjustment member; and
the cushioning member comprises a third cushioning layer covering a partial area of the bar-shaped adjustment member, wherein the partial area comprises a region, which corresponds to a movement track of the second engaging member, and where the plurality of first positioning holes are disposed.

24. The support device according to claim 23, wherein
the bar-shaped adjustment member is made of metal;
each of the plurality of first positioning holes comprises an abutted wall;
the abutted wall is not covered with the second cushioning layer, and is configured to abut against the second engaging member to lock a position of the second leg tube.

25. (canceled)

26. The support device according to claim 23, wherein the bar-shaped adjustment member is made of a cushioning material and forms the cushioning member.

27. The support device according to claim 18, wherein the second engaging member is switched between the locked position and the unlocked position by rotating or moving linearly.

28. The support device according to claim 27, wherein
a first end of the second leg tube is disposed outside the first leg tube, and a second end of the second leg tube is disposed inside the first leg tube and provided with a positioning member; and
a first end of the second engaging member is rotatably connected to the positioning member through a first shaft, and a second end of the second engaging member is configured to engage with or disengage from the corresponding first positioning hole.

29. The support device according to claim 28, wherein
the first end of the second leg tube is provided with a bottom leg;
the locking device further comprises an operating button mounted on the bottom leg, a traction member, and a second elastic restoring member;
the operating button is disposed on the bottom leg, and the traction member and the second elastic restoring member are disposed inside the second leg tube;
the operating button is arranged to, through the traction member, drive the second engaging member to rotate from the locked position to the unlocked position; and
the second elastic restoring member is configured to drive the second engaging member to rotate from the unlocked position to the locked position.

30. The support device according to claim 29, wherein
the traction member is a rod member;
the operating button abuts against a first end of the traction member through a first inclined surface;
a first long hole extending in a height direction of the traction member is disposed at a second end of the traction member, and the first shaft slidably engages with the first long hole; and
among a second end of the traction member and the second engaging member, one is provided with a second long hole extending obliquely, another is provided with a second positioning hole; and a second shaft is disposed in the second long hole and the second positioning hole.

31-32. (canceled)
